(19) United States
(12) Patent Application Publication
(10) Pub. No.: US 2024/0287661 A1
(43) Pub. Date: Aug. 29, 2024

(54) SOFT MAGNETIC MATERIAL AND METHOD FOR PRODUCING SOFT MAGNETIC MATERIAL

(71) Applicant: DAIDO STEEL CO., LTD., Nagoya-shi (JP)

(72) Inventors: Akihiko Saito, Nagoya-shi (JP); Syouai Hashimoto, Nagoya-shi (JP); Tetsuya Yamashita, Nagoya-shi (JP)

(21) Appl. No.: 18/418,729

(22) Filed: Jan. 22, 2024

(30) Foreign Application Priority Data
Jan. 24, 2023 (JP) 2023-008666
Nov. 8, 2023 (JP) 2023-190577

(51) Int. Cl. C22C 38/08; C21D 8/12; C22C 38/02; C22C 38/04; C22C 38/06

(52) U.S. Cl. CPC C22C 38/08; C21D 8/1233; C22C 38/02; C22C 38/04; C22C 38/06

(57) ABSTRACT

The present invention relates to a soft magnetic material including: in tens of mass %, 47%≤Ni≤49%; 0.4%≤Mn≤0.7%; 0.1%≤Si≤0.3%; and 0.01%≤Al≤0.04%, with the balance being Fe and unavoidable impurities, in which a region having a crystal orientation within 10° from a <100> orientation occupies 20% or more on a surface of the soft magnetic material.

### CROSS-REFERENCE TO RELATED APPLICATIONS

This application is based on and claims priority under 35 USC 119 from Japanese Patent Applications No. 2023-008666 filed on Jan. 24, 2023, and No. 2023-190577 filed on Nov. 8, 2023.

### TECHNICAL FIELD

The present invention relates to a soft magnetic material and a method for producing the same, and particularly to a soft magnetic material that can be used to construct a core for a saturable transformer and a method for producing the same.

### BACKGROUND ART

For example, as summarized in Patent Literature 1 below, as a soft magnetic material that requires high controllability, such as a core material for a saturable transformer, it is preferable to use a material having excellent squareness of a magnetization curve. As examples of such a soft magnetic material, a Co-based amorphous alloy and a Fe-based alloy formed of nanocrystal have been used.

Patent Literature 1: JP2000-252111A

### SUMMARY OF THE INVENTION

As described above, the Co-based amorphous alloy and the nanocrystalline magnetic material have excellent squareness of a magnetization curve, but tend to have a large change in magnetic properties with the temperature. Therefore, when the materials are used to construct various devices such as a core for a saturable transformer, an operating point changes greatly with the temperature, making it difficult to exhibit a constant operation due to the temperature. In addition, in the Co-based amorphous alloy and the nanocrystalline magnetic material, a saturation magnetic flux density is not so large, which limits a degree of freedom of application thereof.

Problems to be solved by the present invention is to provide a soft magnetic material having excellent squareness of a magnetization curve, a small change in magnetic properties with the temperature, and a large saturation magnetic flux density, and a method for producing such a soft magnetic material.

In order to solve the above problems, a soft magnetic material and a method for producing a soft magnetic material according to the present invention have the following configurations. [1] A soft magnetic material according to the present invention includes: in terms of mass %, 47%≤Ni≤49%; 0.4%≤Mn≤0.7%; 0.1%≤Si≤0.3%; and 0.01%≤Al≤0.04%, with the balance being Fe and unavoidable impurities, in which a region having a crystal orientation within 10° From a <100> orientation occupies 20% or more on a surface of the soft magnetic material.
[2] In the above aspect [1], regarding a value of a magnetic flux density B100 when a magnetic field of 100 A/m is applied to the soft magnetic material, a change amount of a value of the magnetic flux density B100 in a temperature range of −10° C. or higher and 90° C. or lower may be within a range of ±4% of a value of the magnetic flux density B100 at 25° C.
[3] In the above aspect [1] or [2], regarding a value of a squareness ratio evaluated as Br/B100 that is a ratio of a residual magnetic flux density Br to a magnetic flux density B100 when a magnetic field of 100 A/m is applied to the soft magnetic material, a change amount of a value of Br/B100 in a temperature range of −10° C. or higher and 90° C. or lower may be within a range of ±4% of a value of Br/B100 at 25° C.
[4] In any one of the above aspects [1] to [3], a value of a squareness ratio evaluated as Br/B100 that is a ratio of a residual magnetic flux density Br to a magnetic flux density B100 when a magnetic field of 100 A/m is applied to the soft magnetic material may be 85% or more in a temperature range of −10° C. or higher and 90° C. or lower.
[5] In any one of the above aspects [1] to [4], a value of a magnetic flux density B100 when a magnetic field of 100 A/m is applied to the soft magnetic material may be 1.1 T or more at 25° C.
[6] In any one of the above aspects [1] to [5], ΔB/ΔT, which indicates a gradient of a change in a value of a magnetic flux density B100 when a magnetic field of 100 A/m is applied to the soft magnetic material with a temperature, may be −5 G/° C. or more and 0 G/° C. or less in a temperature range of −10° C. or higher and 90° C. or lower.
[7] In any one of the above aspects [1] to [6], a value of a magnetic flux density B800 when a magnetic field of 800 A/m is applied to the soft magnetic material may be 1.45 T or more at 25° C.

The method for producing a soft magnetic material according to the present invention has the following configuration.
[8] A method for producing a soft magnetic material according to the present invention is a method for producing the soft magnetic material according to any one of the above [1] to [7], and the method includes: a step of performing a cold rolling at a rolling rate of 80% or more.

When the soft magnetic material according to the present invention having the above configuration [1] has the above component composition and a region in which the <100> orientation or a crystal orientation close thereto occupies 20% or more on the surface of the soft magnetic material, it is a soft magnetic material having excellent squareness of a magnetization curve, a small change in magnetic properties with the temperature, and a large saturation magnetic flux density. Therefore, it can be suitably used in applications requiring high controllability, such as a core for a saturable transformer.

In the above aspects [2] to [7], in fact, it is ensured that the soft magnetic material exhibits a small change in magnetic properties with the temperature over a wide temperature range of −10° C. to 90° C. It is also shown that the soft magnetic material has high squareness of a magnetization curve and a large saturation magnetic flux density.

In the method for producing a soft magnetic material according to the present invention having the above configuration [8], the cold rolling is performed at a rolling rate of 80% or more. When the cold rolling is performed at such a high rolling rate, a soft magnetic material in which crystal grains having a <100> orientation or a crystal orientation close thereto occupy many regions on the surface of the soft magnetic material is obtained. The soft magnetic material has excellent squareness of a magnetization curve, a small change in magnetic properties with the temperature, and a large saturation magnetic flux density.

### BRIEF DESCRIPTION OF DRAWINGS

The patent or application file contains at least one drawing executed in color. Copies of this patent or patent application publication with color drawing(s) will be provided by the Office upon request and payment of the necessary fee.’

FIG. 1A shows a SEM image of Example 1.

FIG. 1B shows a SEM image of Comparative Example 1.

FIG. 2A shows IPF maps obtained by EBSD for a region surrounded by a rectangle in FIG. 1A for Example 1.

FIG. 2B shows IPF maps obtained by EBSD for a region surrounded by a rectangle in FIG. 1B for Comparative Example 1. Color drawings are separately submitted.

### DESCRIPTION OF EMBODIMENTS

Hereinafter, a soft magnetic material according to an embodiment of the present invention and a method for producing the same will be described in detail. The soft magnetic material according to the present embodiment has the following component composition and has crystal orientation distribution. In the present description, a content of each element is expressed in terms of mass %.

### Component Composition and Crystal Orientation Distribution of Soft Magnetic Material

The soft magnetic material according to the embodiment of the present invention includes Ni, Mn, Si, and Al in the following predetermined amounts, with the balance being unavoidable impurities and Fe. A shape of the soft magnetic material is not particularly limited, and it is preferably configured as a plate material. The plate material preferably has a thickness of 0.01 mm or more and 0.1 mm or less.

47%≤Ni≤49%

Ni improves magnetic properties such as a saturation magnetic flux density, a residual magnetic flux density, and squareness in the soft magnetic material. When 47%≤Ni, a high effect can be obtained in improving the magnetic properties. It is more preferable that 47.5%≤Ni.

However, when the soft magnetic material includes too much Ni, the magnetic properties may rather worsen. In addition, a material cost of the soft magnetic material increases. From the viewpoint of maintaining high magnetic properties and reducing the material cost, the content of Ni is set to Ni≤49%. It is more preferable that Ni≤48.5%.

0.4%≤Mn≤0.7%

Mn improves cold rolling properties of the soft magnetic material. In the case where the soft magnetic material has high cold rolling properties, the cold rolling can be performed at a high rolling rate while avoiding cracks in the soft magnetic material. As to be described later, when the cold rolling is performed at a high rolling rate, a proportion occupied by the <100> orientation on the surface of the soft magnetic material increases, magnetic properties such as a saturation magnetic flux density and squareness are improved, and a change in magnetic properties with the temperature is reduced. From the viewpoint of sufficiently obtaining the effect of improving the cold rolling properties, the content of Mn is set to 0.4%≤Mn. It is more preferable that 0.45%≤Mn, and it is still more preferable that 0.5%≤Mn. It is particularly preferable that 0.55%≤Mn.

On the other hand, when the content of Mn is too high, magnetic properties such as a magnetic flux density decrease. From the viewpoint of avoiding this, the content of Mn is set to Mn≤0.7%. It is more preferable that Mn≤0.6%.

0.1%≤Si≤0.3%

Si increases efficiency of melting and producing an alloy material. This is because Si has a deoxidizing effect, and by adding Si, deoxidation can be efficiently carried out during melt production. From the viewpoint of sufficiently obtaining the effect, the content of Si is set to 0.1%≤Si. It is more preferable that 0.15%≤Si.

On the other hand, including a large amount of Si leads to a decrease in workability of the soft magnetic material. From the viewpoint of avoiding this, the content of Si is set to Si≤0.3%. It is more preferable that Si≤0.25%.

0.01%≤Al≤0.04%

Al constitutes a nitride, and when the nitride forms a solid solution in a matrix phase, a pinning effect of crystal grain boundaries is less likely to occur. Therefore, by adding a small amount of Al to the soft magnetic material, coarse graining of crystal grains is promoted. In order to sufficiently obtain the effect, Al is added at a concentration of 0.01%≤Al. The nitride of Al is easily solid-dissolved in the matrix phase by magnetic annealing at 1100° C. for example. From the viewpoint of improving the effect, it is more preferable that 0.015%≤Al.

On the other hand, when Al remains in the matrix phase, it is a factor in decrease in magnetic properties. From the viewpoint of preventing this, the content of Al is set to Al≤0.04%. It is more preferable that Al≤0.035%. It is still more preferable that Al≤0.030%.

In the soft magnetic material according to the present embodiment, including unavoidable impurities is permitted within a range that does not remarkably impair the magnetic properties of the soft magnetic material. Specific examples of the unavoidable impurities include, in terms of mass %, C≤0.02%, P≤0.1%, S≤0.002%, Cu≤0.10%, Cr≤0.10%, Mo≤0.10%, Pb≤0.01%, Co≤0.10%, As≤0.10%, Sn≤0.005%, Ti≤0.010%, Ca≤0.020%, O≤0.0030%, N≤0.030%, Sb≤0.0030%, Mg≤0.0010%, Zn≤0.0030%, Ag≤0.0010%, and Bi≤0.10%.

In the soft magnetic material according to the present embodiment, a region having a <100> orientation occupies 20% or more on the surface of the soft magnetic material. Here, it is evaluated as the proportion occupied by the <100> orientation, including cases where the crystal orientation is within 10° From the complete <100> orientation (the same applies below). Specifically, the <100> orientation in the present embodiment is equivalent to [100] orientation, [010] orientation, and [001] orientation. In addition, the proportion occupied by a predetermined crystal orientation is expressed by an area proportion on the surface of the soft magnetic material.

When the region having a <100> orientation occupies a large area of 20% or more on the surface of the soft magnetic material, in addition to the effects of the soft magnetic material including the above component composition, high magnetic properties such as high squareness, a large saturation magnetic flux density, and a large residual magnetic flux density can be obtained. In addition, changes in these magnetic properties with the temperature are reduced. This is considered to be associated with an increased residual magnetic flux density or magnetic permeability when an easy axis of magnetization of a Fe—Ni alloy, which has a face-centered cubic structure, is in the <100> orientation, and many regions where the crystal orientation is oriented to the easy axis of magnetization are formed on the surface of the soft magnetic material. From the viewpoint of improving the effects of improving the magnetic properties and preventing changes in magnetic properties with the temperature, it is more preferable that the proportion of the region having a <100> orientation on the surface of the soft magnetic material is 25% or more. Since the higher the proportion of the region having a <100> orientation, the more preferred it is, there is no particular upper limit. The crystal orientation distribution on the surface of the soft magnetic material may be evaluated by electron back scattered diffraction (EBSD).

In the soft magnetic material according to the present embodiment, a crystal grain size on the surface thereof is not particularly limited as long as the proportion of the region having a <100> orientation on the surface thereof is 20% or more. However, the soft magnetic material according to the present embodiment tends to have a coarse grain structure, and preferably has a crystal grain size of 20 μm or more, for example.

### Magnetic Properties and Change with Temperature of Soft Magnetic Material

When the soft magnetic material according to the present embodiment includes Ni, Mn, Si, and Al in predetermined amounts as described above, and has a proportion of the region having a <100> orientation on the surface of the soft magnetic material of 20% or more, high magnetic properties, including high squareness and a large saturation magnetic flux density are obtained. In addition, changes in magnetic properties with the temperature can be kept small over a wide temperature range. With these properties, the soft magnetic material according to the present embodiment can be suitably used in applications requiring high controllability, including a core for a saturable transformer. Moreover, it can exhibit stable properties over a wide temperature range. The soft magnetic material according to the present embodiment can exhibit, for example, the following magnetic properties and changes therein with the temperature by having the above predetermined component composition and crystal orientation distribution.

### Saturation Magnetic Flux Density

As an index of the saturation magnetic flux density. B100 can be used. Here, the B100 is a magnetic flux density when a magnetic field of 100 A/m is applied to the soft magnetic material. A direction in which the magnetic field is applied is an in-plane rolling direction of a plate-shaped soft magnetic material (hereinafter, the same applies to the application of the magnetic field in the evaluation of the magnetic properties). The soft magnetic material according to the present embodiment has the value of the B100 of preferably 1.1 T or more, and more preferably 1.2 T or more, at least at 25° C. (room temperature). Still more preferably, the value of the B100 may be 1.1 T or more or 1.2 T or more over the entire range of −10° C. or higher and 90° C. or lower. The larger the value of the B100 is, the more preferred it is, and there is no particular upper limit.

Further, as an index that more accurately reflects the saturation magnetic flux density, B800 can be used. Here, the B800 is a magnetic flux density when a magnetic field of 800 A/m is applied to the soft magnetic material. The soft magnetic material according to the present embodiment has the value of the B800 of preferably 1.45 T or more at least at 25° C. The larger the value of the B800 is, the more preferred it is, and there is no particular upper limit.

### Squareness

As a squareness ratio indicating the squareness of the magnetization curve, Br/B100 can be used. Here, the B100 is the magnetic flux density when a magnetic field of 100 A/m is applied to the soft magnetic material as described above, and Br is the residual magnetic flux density. Then, the Br/B100, which is a ratio of Br to B100, is evaluated as the squareness ratio. The soft magnetic material according to the present embodiment has the value of the squareness ratio Br/B100 of preferably 85% or more, more preferably 87% or more, and still more preferably 88% or more in a temperature range of −10° C. to 90° C. In addition, the value of the Br/B100 is preferably 90% or more, and more preferably 91% or more at least at 25° C. The larger the squareness ratio is, the more preferred it is, and there is no particular upper limit to the value of the Br/B100.

The value of the residual magnetic flux density Br is not particularly limited, and is preferably 1.0 T or more, and more preferably 1.1 T or more or more at least at 25° C. Still more preferably, the value of the residual magnetic flux density Br may be 1.0 T or more or 1.1 T or more over the entire range of −10° C. or higher and 90° C. or lower. The larger the value of the residual magnetic flux density Br is, the more preferred it is, and there is no particular upper limit.

Changes in Magnetic Properties with Temperature

First, attention will be paid to a change in B100 with the temperature, the B100 being an index of the saturation magnetic flux density. In the soft magnetic material according to the present embodiment, a change amount of a value of B100 in a temperature range of −10° C. or higher and 90° C. or lower is preferably within a range of ±4%, more preferably within a range of ±3%, and still more preferably within a range of ±1% of a value of B100 at 25° C. Accordingly, a small change in saturation magnetic flux density with the temperature is ensured. The smaller the change in B100 with the temperature is, the more preferred it is, and there is no particular lower limit to a size of a change width.

In addition, it is preferable that ΔB/ΔT, which indicates a gradient of the change in the value of B100 with the temperature, is −5 G/° C. or more and 0 G/° C. or less in a temperature range of −10° C. or higher and 90° C. or lower. The saturation magnetic flux density tends to decrease as the temperature rises, but the extent of the decrease can be kept small by keeping the ΔB/ΔT within the above range. The ΔB/ΔT is more preferably −3 G/° C. or more, and still more preferably −2 G/° C. or more.

Further, in the soft magnetic material according to the present embodiment, it is preferable that a change in squareness with the temperature is also kept small. Specifically, it is preferable that a change amount of the value of the squareness ratio Br/B100 in a temperature range of −10° C. to 90° C. is preferably within a range of ±4%, and more preferably within a range of ±3% of the value of the squareness ratio Br/B100 at 25° C. The smaller the change in squareness ratio with the temperature is, the more preferred it is, and there is no particular lower limit to upper and lower widths.

### Method for Producing Soft Magnetic Material

Hereinafter, the method for producing a soft magnetic material according to an embodiment of the present invention will be described. When the production method according to the present embodiment is used, the soft magnetic material according to the embodiment of the present invention described above can be suitably produced.

The production method according to the present embodiment includes a step of performing a cold rolling at a predetermined rolling rate to produce a plate-shaped soft magnetic material. Specifically, first, an alloy material having a predetermined component composition is melted and cast. Then, hot working and annealing are suitably performed, and then the cold rolling and further magnetic annealing are performed, to thereby obtain a soft magnetic material. As described above, the thickness of the plate material after the cold rolling is preferably 0.01 mm or more and 0. 1 mm or less.

During the cold rolling, when the rolling rate is increased, the proportion of the region having a <100> orientation increases on the surface of the soft magnetic material. As a result, in addition to the effect of the component composition, a high effect can be obtained in improving the magnetic properties and preventing the changes in magnetic properties with the temperature. Specifically, the rolling rate in the cold rolling is set to 80% or more. It is more preferable to set the rolling rate to 90%. On the other hand, from the viewpoint of reducing the processing cost and from the viewpoint of preventing a decrease in magnetic flux density, it is preferable to keep the rolling rate during the cold rolling to less than 95%. In the production method according to the present embodiment, when the rolling rate during the cold rolling is 80% or more and less than 95%, the value of the B100 at 25° C. (room temperature) is likely to be 1.1 T or more in the soft magnetic material to be produced. An example of the magnetic annealing temperature is 1100° C.

### EXAMPLES

Hereinafter, the present invention will be described more specifically with reference to Examples. The present invention is not limited by these Examples.

### Preparation of Sample

As Examples 1 and 2 and Comparative Examples 1 to 5, a plate-shaped soft magnetic material having a component composition (including Ni, Mn, Si, and Al at the indicated concentrations in terms of mass %, with the balance being unavoidable impurities and Fe) and a cold rolling rate as shown in Table 1 was prepared. As a specific production method, metal materials having a composition ratio were melted in a vacuum induction furnace, etc., and a material having a plate thickness of 0.2 mm was subjected to the cold rolling at the rolling rate indicated in Table 1. Thereafter, the obtained plate material was rolled in the rolling direction to obtain a wound core-shaped sample. Further, the wound core-shaped sample was subjected to magnetic annealing (1100° C.×2 hours, hydrogen atmosphere).

In addition, as Reference Example 1, a soft magnetic material made of a Co-based amorphous alloy was prepared. Specifically, a saturable core “MT series” for a magnetic amplifier manufactured by Toshiba Corporation was used as Reference Example 1.

### Test Methods

### (1) Crystal Orientation Distribution

Scanning electron microscopy (SEM) observation and electron back scattered diffraction (EBSD) measurement using a SEM device were performed on a part of the sample. An inverse pole figure orientation map (IPF map) was created from the results of the EBSD measurement, and the crystal orientation distribution of the structure was analyzed

(2) Magnetic Properties and Change with Temperature

The wound core of each sample was used as a magnetic ring (iron core). Using this magnetic ring, a primary coil and a secondary coil were formed and used as measurement samples. Then, the magnetic flux density was measured using a magnetic measuring device. The magnetic flux density was measured by passing a current through the primary coil to generate a magnetic field H in the magnetic ring, and calculating the magnetic flux density B generated in the magnetic ring based on an integral value of a voltage induced in the secondary coil. A magnetization curve (BH curve) was obtained, and the magnetic properties of each sample were evaluated based on an obtained hysteresis loop.

Specifically, the following parameters regarding the magnetic properties were obtained based on measurement results at room temperature (25° C.) for each sample. ·B100: magnetic flux density when a magnetic field of 100 A/m is applied to the sample·Br: residual magnetic flux density·Br/B100: squareness ratio·B800: magnetic flux density when a magnetic field of 800 A/m is applied to the sample

Further, for Examples 1 and 2 and Reference Example 1, the magnetic properties were evaluated in the same manner as above at a plurality of temperatures in the range of −10° C. to 90° C., and based on the obtained results, the following properties related to changes in magnetic properties with the temperature were evaluated. ·ΔB100: the change amount of the value of the B100 at each temperature based on the value of the B100 at 25° C.·Δ(Br/B100): the change amount of the value of the squareness ratio Br/B100 at each temperature based on the value of the squareness ratio Br/B100 at 25° C.·ΔB/ΔT: the gradient of a change in the value of B100 with the temperature, which is calculated by dividing the change amount of the value of the B100 from −10° C. to 90° C. by the amount of temperature change (100° C.).

### Test Results

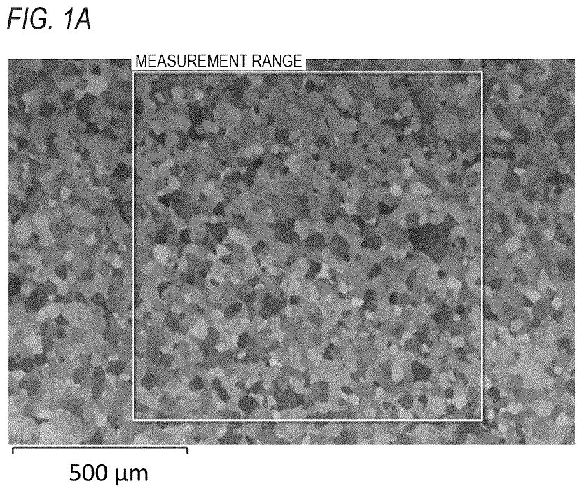

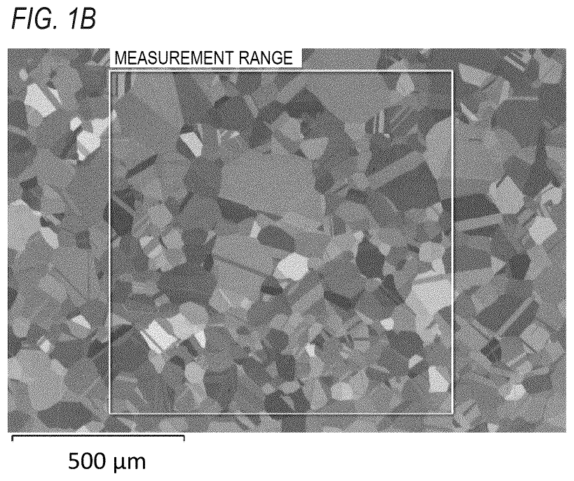

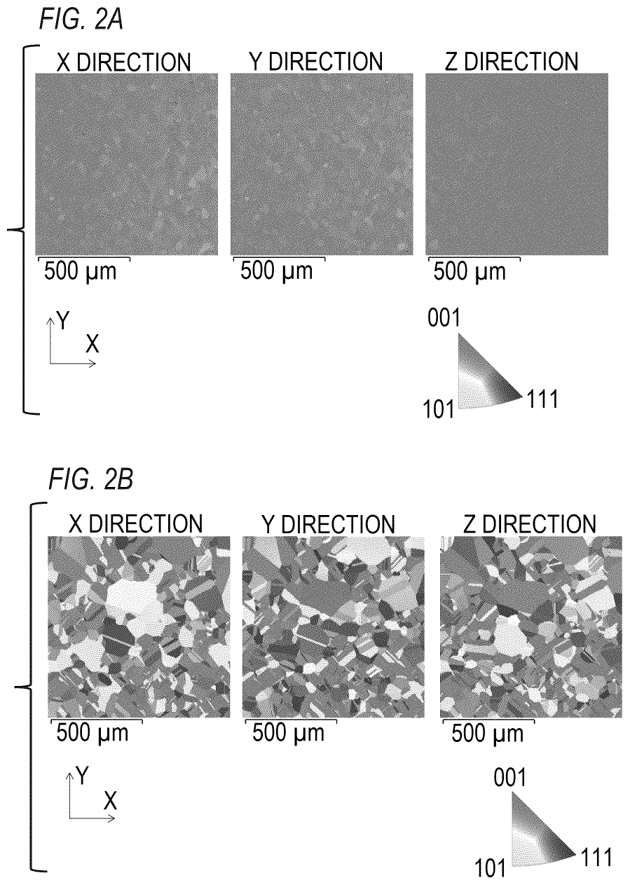

FIGS. 1A and 1B show SEM images of samples in Example 1 and Comparative Example 1, respectively. In addition, FIGS. 2A and 2B show IPF maps obtained by EBSD for the samples in Example 1 and Comparative Example 1, respectively. Further, Table 1 below shows the component composition, the cold rolling rate, and various magnetic properties and changes therein with the temperature of Examples 1 and 2, Comparative Examples 1 to 5, and Reference Example 1. Table 1 also shows the proportion of the region having a crystal 10 orientation within 10° From the <100> orientation, which are obtained by EBSD for some samples. Regarding Comparative Example 5, various evaluations could not be performed because cracks occurred in the sample during cold rolling.

TABLE 1

| | | Cold | Temperature | B100 | | Br/B100 |
|---|---|---|---|---|---|---|
| | Component composition | rolling rate | [° C.] | [T] | Br [T] | [%] |
| Example 1 | Fe—48Ni—0.5Mn—0.2Si—0.02Al | 90% | −10 | 1.28 | 1.18 | 92.0 |
| | | | 0 | 1.28 | 1.18 | 92.1 |
| | | | 25 | 1.28 | 1.17 | 91.5 |
| | | | 50 | 1.27 | 1.15 | 90.7 |
| | | | 60 | 1.26 | 1.14 | 90.1 |
| | | | 90 | 1.25 | 1.11 | 88.9 |
| Example 2 | | 85% | −10 | 1.19 | 1.09 | 91.2 |
| | | | 0 | 1.19 | 1.07 | 90.5 |
| | | | 25 | 1.19 | 1.08 | 90.2 |
| | | | 50 | 1.19 | 1.06 | 89.0 |
| | | | 60 | 1.18 | 1.06 | 89.2 |
| | | | 90 | 1.18 | 1.03 | 87.4 |
| Comparative Example 1 | Fe—48Ni—0.5Mn—0.2Si—0.02Al | 50% | 25 | 1.02 | 0.80 | 78.0 |
| Comparative Example 2 | | 60% | 25 | 1.05 | 0.79 | 75.0 |
| Comparative Example 3 | Fe—45Ni—0.5Mn—0.2Si—0.02Al | 85% | 25 | 1.23 | 0.92 | 74.6 |
| Comparative Example 4 | Fe—55Ni—0.5Mn—0.2Si—0.02Al | 85% | 25 | 1.01 | 0.77 | 76.0 |
| Comparative Example 5 | Fe—48Ni—0.2Mn—0.2Si—0.02Al | 85% | — | — | — | — |
| Reference Example 1 | Co-based amorphous alloy | — | −10 | 0.45 | 0.42 | 95.0 |
| | | | 0 | 0.44 | 0.42 | 94.9 |
| | | | 25 | 0.42 | 0.40 | 94.9 |
| | | | 50 | 0.41 | 0.38 | 94.8 |
| | | | 60 | 0.40 | 0.38 | 94.9 |
| | | | 90 | 0.37 | 0.35 | 94.7 |

| | B800 [T] | ΔB100 | Δ(Br/B100) | ΔB/ΔT [G/° C.] | <100> proportion |
|---|---|---|---|---|---|
| Example 1 | 1.48 | 0.0% | 0.5% | −3 | 25% |
| | — | 0.0% | 0.7% | | |
| | 1.47 | 0.0% | 0.0% | | |
| | 1.45 | −0.8% | −0.9% | | |
| | — | −1.6% | −1.5% | | |
| | 1.42 | −2.3% | −2.8% | | |
| Example 2 | 1.47 | 0.0% | 1.1% | −1 | 21% |
| | — | 0.0% | 0.3% | | |
| | 1.47 | 0.0% | 0.0% | | |
| | 1.46 | 0.0% | −1.3% | | |
| | — | −0.8% | −1.1% | | |
| | 1.44 | −0.8% | −3.1% | | |
| Comparative Example 1 | — | — | — | — | 5% |
| Comparative Example 2 | — | — | — | — | — |
| Comparative Example 3 | — | — | — | — | 3% |
| Comparative Example 4 | — | — | — | — | 5% |
| Comparative Example 5 | — | — | — | — | — |
| Reference Example 1 | — | 7.1% | 0.1% | −8 | — |
| | — | 4.8% | 0.0% | | |
| | 0.57 | 0.0% | 0.0% | | |
| | — | −2.4% | −0.1% | | |
| | | −4.8% | 0.0% | | |
| | — | −11.9% | −0.2% | | |

### (1) Crystal Orientation Distribution

Based on FIGS. 1A and 1B and FIGS. 2A and 2B, the crystal structure distribution will be compared between Example 1 and Comparative Example 1. Both Example 1 and Comparative Example 1 have a component composition of Fe-48Ni-0.5Mn-0.2Si-0.02Al, and differ only in the rolling rate during the cold rolling. The rolling rate during the cold rolling is 90% in Example 1 and 50% in Comparative Example 1.

In the SEM images in FIGS. 1A and 1B, in both Example 1 and Comparative Example 1, the structure is composed of a collection of crystal grains, and the difference in orientation of the crystal grains causes contrast. However, there is a difference in crystal grain size between Example 1 and Comparative Example 1, with Example 1 having a smaller crystal grain size. The crystal grain size is generally distributed in the range of 20 μm to 70 μm in Example 1, and in the range of 50 μm to 300 μm in Comparative Example 1.

FIGS. 2A and 2B show IPF maps obtained by EBSD for a rectangular region in the SEM image in FIGS. 1A and 1B for the samples in Example 1 and Comparative Example 1, respectively. Here, the crystal orientation is shown in three directions, X, Y, and Z (the Z direction is perpendicular to the surface). As can be seen that in FIG. 2B, crystal grains having greatly different display colors coexist, whereas in FIG. 2A, the difference in display color between the crystal grains is clearly smaller. As is clear in the color drawings, many crystal grains in FIG. 2A have a crystal orientation close to the <100> orientation.

Quantitative analysis of crystal orientation based on each IPF map reveals that, as summarized in Table 1, the proportion of the region having a crystal orientation within 10° from the <100> orientation is 25% in Example 1 in FIG. 2A. On the other hand, it is 5% in Comparative Example 1 in FIG. 2B. In other words, in Example 1, in which the rolling rate during the cold rolling is high, the proportion occupied by the <100> orientation on the surface of the soft magnetic material is significantly higher. Regarding the soft magnetic material having the same component composition as that of the above Example 1 and Comparative Example 1, in Example 2 in which the rolling rate during the cold rolling is 85%, the proportion occupied by the <100> orientation is evaluated in the same manner, and as in Example 1, it is 20% or more.

In this way, it can be seen, from comparison between Examples 1 and 2 and Comparative Example 1 both having the component composition of Fe-48Ni-0.5Mn-0.2Si-0.02Al, that by increasing the rolling rate during the cold rolling, the proportion occupied by the <100> orientation on the surface of the soft magnetic material increases, and by increasing the rolling rate to 80% or more, the proportion occupied by the <100> orientation is a high value of 20% or more. As will be described later, by increasing the proportion occupied by the <100> orientation, a high effect of improving the magnetic properties and preventing the changes in magnetic properties with the temperature can be obtained.

However, the proportion occupied by the <100> orientation on the surface of the soft magnetic material depends not only on the rolling rate during the cold rolling but also on the component composition of the soft magnetic material. As shown in Table 1, in Comparative Example 3, the content of Ni is less than 47%, and in Comparative Example 4, the content of Ni is more than 49%. In both Comparative Examples 3 and 4, the rolling rate during the cold rolling is 85%, which is the same as in Example 2, but the proportion occupied by the <100> orientation on the surface of the soft magnetic material is a low value of 5% or less. From these facts, it can be said that when the soft magnetic material has a component composition including 47%≤Ni≤49% in addition to 0.4%≤Mn≤0.7%, 0.1%≤Si≤0.3%, and 0.01%≤Al≤0.04%, and has a rolling rate of 80% or more during the cold rolling, the proportion occupied by the <100> orientation on the surface of the soft magnetic material can be increased to 20% or more.

### (2) Magnetic Properties and Change With Temperature

According to Table 1, in Examples 1 and 2 in which the soft magnetic material includes 47%≤Ni≤49%, 0.4%≤Mn≤0.7%, 0.1%≤Si≤0.3%, and 0.01%≤Al≤0.04% and has the proportion of the <100> orientation on the surface of the soft magnetic material of 20% or more, at least at 25° C., the value of the B100 is 1.1 T or more, the value of the residual magnetic flux density Br is 1.0 T or more, the value of the squareness ratio Br/B100 is 90% or more, and the B800 is 1.45 T or more, and a soft magnetic material having high magnetic properties, including a large saturation magnetic flux density, a large residual magnetic flux density, and high squareness is obtained. Particularly, the values of the B100, the Br, and the B800 are significantly larger than the values of them in Co-based amorphous alloy of Reference Example 1. Comparing Example 1 and Example 2, particularly excellent magnetic properties are obtained in Example 1 where the cold rolling rate is as high as 90%.

Further, when attention is paid to the changes in magnetic properties with the temperature, in both Examples 1 and 2, the change ΔB100 in the value of the B100 with the temperature is within ±4% and the change Δ(Br/B100) in squareness with the temperature is within ±4% in the range of −10° C. to 90° C. In addition, the gradient ΔB/ΔT of the change in the value of the B100 with the temperature is within the range of −5 G/° C. or more and 0 G/° C. or less. In this way, the changes in magnetic properties with the temperature are reduced. Particularly, the ΔB100 and the ΔB/ΔT are significantly less than the values of the Co-based amorphous alloy in Reference Example 1. Comparing Example 1 and Example 2, the changes in magnetic properties with the temperature are particularly kept small in Example 1 where the cold rolling rate is as high as 90%.

Comparative Examples 1 and 2 have the same alloy composition as that in Examples 1 and 2, but the cold rolling rates are less than 80%, being 50% and 60%, respectively. As described above, corresponding to the difference in rolling rate, the proportion occupied by the <100> orientation on the surface of the soft magnetic material is 20% or more in Examples 1 and 2, while it is as small as 5% in Comparative Example 1. In Comparative Examples 1 and 2, the values of the B100, the residual magnetic flux density Br, and the squareness ratio Br/B100 are all lower those in Examples 1 and 2. In other words, it can be said that in Comparative Examples 1 and 2, the rolling rate during the cold rolling is low and the proportion of the <100> orientation on the surface of the soft magnetic material is small, so that high magnetic properties are not obtained.

In Comparative Example 3, the content of Ni is less than 47%. On the contrary, in Comparative Example 4, the content of Ni is more than 49%. In both Comparative Examples 3 and 4, as described above, the proportion occupied by the <100> orientation on the surface of the soft magnetic material is small, and the magnetic properties are also poor. That is, in both Comparative Examples 3 and 4, the value of the residual magnetic flux density Br is smaller and the value of the squareness ratio Br/B100 is also smaller than those in Example 2 in which the same rolling rate is used. Further, in Comparative Example 4, the value of the B100 is also smaller. These results indicate that sufficiently high magnetic properties cannot be obtained when the content of Ni is too high or too low.

In Comparative Example 5, the content of Mn is less than 0.4%. In Comparative Example 5, cracks occur during the cold rolling, making it impossible to evaluate the properties. It is considered that the cracks occur because the effect of Mn on improving the cold rolling properties is not sufficiently obtained. In the soft magnetic material according to the present embodiment, as is clear from the comparison between Examples 1 and 2 and Comparative Examples 1 and 2, it can be said that it is important to sufficiently increase the cold rolling rate and increase the proportion of the <100> orientation on the surface of the soft magnetic material in order to obtain high magnetic properties, and it is necessary to include a sufficient amount of Mn in order to increase the cold rolling rate.

As described above, it is confirmed from the comparison between each Example and Comparative Example that when the soft magnetic material has a component composition including 47%≤Ni≤49%, 0.4%≤Mn≤0.7%, 0.1%≤Si≤0.3%, and 0.01%≤Al≤0.04%, with the balance being Fe and unavoidable impurities, and has a crystal orientation distribution in which the region having a crystal orientation within 10° From the <100> orientation occupies 20% or more on the surface of the soft magnetic material, the soft magnetic material has high magnetic properties such as a large saturation magnetic flux density, a large residual magnetic flux density, and high squareness, and has low temperature dependence in magnetic properties.

The embodiments and Examples of the present invention have been described above The present invention is not particularly limited to these embodiments and Examples, and various modifications may be made.

The present application is based on Japanese Patent Applications No. 2023-008666 filed on January 24, 2023, and No. 2023-190577 filed on Nov. 8, 2023, and the contents thereof are incorporated herein by reference.

What is claimed is:

1. A soft magnetic material comprising: in terms of mass %,
47%≤Ni≤49%;
0.4%≤Mn≤0.7%;
0.1%≤Si≤0.3%; and
0.01%≤Al≤0.04%,
with the balance being Fe and unavoidable impurities, wherein
a region having a crystal orientation within 10° From a <100> orientation occupies 20% or more on a surface of the soft magnetic material.

2. The soft magnetic material according to claim 1, wherein, regarding a value of a magnetic flux density B100 when a magnetic field of 100 A/m is applied to the soft magnetic material, a change amount of a value of the magnetic flux density B100 in a temperature range of −10° C. or higher and 90° C. or lower is within a range of ±4% of a value of the magnetic flux density B100 at 25° C.

3. The soft magnetic material according to claim 1, wherein, regarding a value of a squareness ratio evaluated as Br/B100 that is a ratio of a residual magnetic flux density Br to a magnetic flux density B100 when a magnetic field of 100 A/m is applied to the soft magnetic material, a change amount of a value of Br/B100 in a temperature range of −10° C. or higher and 90° C. or lower is within a range of ±4% of a value of Br/B100 at 25° C.

4. The soft magnetic material according to claim 1, wherein a value of a squareness ratio evaluated as Br/B100 that is a ratio of a residual magnetic flux density Br to a magnetic flux density B100 when a magnetic field of 100 A/m is applied to the soft magnetic material is 85% or more in a temperature range of −10° C. or higher and 90° C. or lower.

5. The soft magnetic material according to claim 1, wherein a value of a magnetic flux density B100 when a magnetic field of 100 A/m is applied to the soft magnetic material is 1.1 T or more at 25° C.

6. The soft magnetic material according to claim 1, wherein ΔB/ΔT, which indicates a gradient of a change in a value of a magnetic flux density B100 when a magnetic field of 100 A/m is applied to the soft magnetic material with a temperature, is −5 G/° C. or more and 0 G/° C. or less in a temperature range of −10° C. or higher and 90° C. or lower.

7. The soft magnetic material according to claim 1, wherein a value a magnetic flux density B800 when a magnetic field of 800 A/m is applied to the soft magnetic material is 1.45 T or more at 25° C.

8. A method for producing the soft magnetic material according to claim 1, the method comprising:
a step of performing a cold rolling at a rolling rate of 80% or more.
